(19) United States
(12) Patent Application Publication
(10) Pub. No.: US 2025/0095232 A1
(43) Pub. Date: Mar. 20, 2025

(54) HUMAN COLOR DISCRIMINATION FOR MEMORY-EFFICIENT ENCODING IN EXTENDED REALITY

(71) Applicants: University of Rochester, Rochester, NY (US); New York University, New York, NY (US)

(72) Inventors: Yuhao Zhu, Rochester, NY (US); Qi Sun, New York, NY (US); Nisarg Ujjainkar, Rochester, NY (US); Ethan Shahan, Rochester, NY (US); Kenneth Chen, New York, NY (US); Budmonde Duinkharjav, Long Island City, NY (US)

(21) Appl. No.: 18/884,550

(22) Filed: Sep. 13, 2024

Related U.S. Application Data
(60) Provisional application No. 63/583,034, filed on Sep. 15, 2023.
(60) Provisional application No. 63/583,017, filed on Sep. 15, 2023.

(51) Int. Cl. G06T 11/00; G06T 7/90

(52) U.S. Cl. CPC G06T 11/001; G06T 7/90

(57) ABSTRACT

Memory-efficient encoding based on human-color perception can include calculating a plurality of two-dimensional boundaries in a color space, ascertaining extrema points for two or more two-dimensional boundaries of the plurality of two-dimensional boundaries, adjusting a color value within at least one of the two-dimensional boundaries to generate an adjusted color that reduces variances of color values for a color channel, and presenting the adjusted color on the display. By adjusting color values within human-perception limits, the number of bits used for color encoding can be reduced.

### CROSS-REFERENCE TO RELATED APPLICATIONS

This application claims priority to U.S. Provisional Patent Application No. 63/583,034, filed on Sep. 15, 2023, and U.S. Provisional Patent Application No. 63/583,017, filed on Sep. 15, 2023, the disclosures of which are incorporated by reference in their entirety for all purposes.

The following two U.S. Patent Applications, including this one, are being filed concurrently, and the entire disclosure of the other application is incorporated by reference into this application for all purposes:
U.S. Patent Application No. ______, filed Sep. 13, 2024, entitled “COLOR-PERCEPTION-GUIDED DISPLAY POWER REDUCTION FOR EXTENDED REALITY” (Attorney Docket No. 096027-1449758); and
U.S. Patent Application No. ______, filed Sep. 13, 2024, entitled “HUMAN COLOR DISCRIMINATION FOR MEMORY-EFFICIENT ENCODING IN EXTENDED REALITY” (Attorney Docket No. 096027-1449757).

### STATEMENT REGARDING FEDERALLY SPONSORED RESEARCH OR DEVELOPMENT

This invention was made with government support under CNS-2225860 and CCF-2044963 awarded by the National Science Foundation. The government has certain rights in the invention.

### BACKGROUND

Battery life is an increasingly urgent challenge for today's untethered virtual-reality and augmented-reality devices. However, the power efficiency of head-mounted displays is naturally at odds with growing computational requirements driven by better resolution, refresh rate, and dynamic ranges, all of which reduce the sustained usage time of untethered virtual-reality and augmented-reality devices. There is a need for further power-savings features for virtual-reality and augmented-reality devices.

### BRIEF SUMMARY

In some configurations, a system, for memory-efficient encoding in an extended-reality system, comprises a display and one or more memory devices comprising instructions that, when executed by one or more processors, causes the one or more processors to perform the following steps: calculating a plurality of two-dimensional boundaries in a color space; ascertaining extrema points for two or more two-dimensional boundaries of the plurality of two-dimensional boundaries; adjusting a color value within at least one of the two-dimensional boundaries to generate an adjusted color that reduces variances of color values for a color channel, based on ascertaining the extrema points for the two or more two-dimensional boundaries; and/or presenting the adjusted color on the display. In some embodiments, the two-dimensional boundaries are ascertained based on human color discrimination; the plurality of two-dimensional boundaries are cross sections from a plurality of color-discrimination ellipsoids; ascertaining extrema points comprises ascertaining H and/or L for each of the plurality of the two-dimensional boundaries, where H is a high value of an ellipse and L is a low value of the ellipse, identifying a HL value and a LH value, where HL is a highest of low values L and LH is a lowest of high values H for the plurality of two-dimensional boundaries, and adjusting the color value within at least one of the two-dimensional boundaries to reduce variances of color values for the color channel is based on the HL value and/or the LH value; the color value in the at least one of the two-dimensional boundaries is adjusted to equal HL or LH, based on HL being greater than LH; and/or each ellipsoid of the plurality of color-discrimination ellipsoids corresponds to a color for a pixel in an image.

In some configurations, a method for memory-efficient encoding in an extended-reality device comprises calculating a plurality of two-dimensional boundaries in a color space; ascertaining extrema points for two or more two-dimensional boundaries of the plurality of two-dimensional boundaries; adjusting a color value within at least one of the two-dimensional boundaries to generate an adjusted color that reduces variances of color values for a color channel, based on ascertaining the extrema points for the two or more two-dimensional boundaries; and/or presenting the adjusted color on a display. In some embodiments, the two-dimensional boundaries are ascertained based on human color discrimination and a function of an angle of a field of view of a person; the plurality of two-dimensional boundaries are cross sections from a plurality of color-discrimination ellipsoids; ascertaining extrema points comprises ascertaining H and/or L for each of the plurality of the two-dimensional boundaries, where His a high value of an ellipse and L is a low value of the ellipse, and identifying a HL value and a LH value, where HL is a highest of low values L and LH is a lowest of high values H for the plurality of two-dimensional boundaries; adjusting the color value within at least one of the two-dimensional boundaries to reduce variances of color values for the color channel is based on the HL value and/or the LH value; the color value in the at least one of the two-dimensional boundaries is adjusted to equal HL or LH, based on HL being greater than LH; the color value in the at least one of the two-dimensional boundaries is adjusted to a value P, based on HL being greater than LH, wherein the value P is a value equal to or less than LH and equal to or greater than H; the value P is an average of HL and LH; each ellipsoid of the plurality of color-discrimination ellipsoids corresponds to a color for a pixel in an image; and/or the color channel is blue or red and not green.

In some configurations, a memory device comprising instructions that, when executed by one or more processors, cause the one or more processors to perform the following steps: calculating a plurality of two-dimensional boundaries in a color space; ascertaining extrema points for two or more two-dimensional boundaries of the plurality of two-dimensional boundaries; adjusting a color value within at least one of the two-dimensional boundaries to generate an adjusted color that reduces variances of color values for a color channel, based on ascertaining extrema points for the two or more two-dimensional boundaries; and/or presenting the adjusted color on a display. In some embodiments, the plurality of two-dimensional boundaries are cross sections from a plurality of color-discrimination ellipsoids; ascertaining extrema points comprises ascertaining H and/or L for each of the plurality of the two-dimensional boundaries, where His a high value of an ellipse and L is a low value of the ellipse, and identifying a HL value and a LH value, where HL is a highest of low values L and LH is a lowest of high values H for the plurality of two-dimensional boundaries; adjusting the color value within at least one of the two-dimensional boundaries to reduce variances of color values for the color channel is based on the HL value and/or the LH value; wherein the color value in the at least one of the two-dimensional boundaries is adjusted to a value P, based on HL being greater than LH, wherein the value P is a value equal to or less than LH and equal to or greater than HL; each ellipsoid of the plurality of color-discrimination ellipsoids corresponds to a color for a pixel in an image; the color space is a first color space; calculating the plurality of two-dimensional boundaries comprises transforming a plurality of axis-aligned ellipsoids from a second color space into a plurality of color-discrimination ellipsoids in the first color space; the second color space is the DKL (Derrington-Krauskopf-Lennie) space; the first color space is the linear RGB (Red, Green, Blue) space; the color channel is a first color channel; the instructions are configured to further cause the one or more processors to reduce variances of color values for a second color channel; and/or neither the first color channel nor the second color channel is green.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

The present disclosure is described in conjunction with the appended figures.

FIG. 1 is a block diagram of data communication traffic in an embodiment of an XR system.

FIG. 2 shows an example of BD compression.

FIG. 3 is an example embodiment of a first plot of a projection of a first set of ellipsoids onto the B-G plane.

FIG. 4 is an example embodiment of a second plot of a projection of a second set of ellipsoids onto the B-G plane.

FIG. 5 is an illustration of an embodiment for how color adjustment fits in an embodiment of an overall rendering and compression pipeline.

FIG. 6 is a block diagram of an embodiment of a system on a chip comprising a Color Adjustment Unit.

FIG. 7 is a flowchart of an embodiment of a process for memory-efficient encoding in an extended-reality device.

FIG. 8 depicts an embodiment of a head-mounted device.

FIG. 9 depicts a block diagram of an embodiment of a computer system.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides preferred exemplary embodiment(s) only, and is not intended to limit the scope, applicability, or configuration of the disclosure. Rather, the ensuing description of the preferred exemplary embodiment(s) will provide those skilled in the art with an enabling description for implementing a preferred exemplary embodiment. It is understood that various changes may be made in the function and arrangement of elements without departing from the spirit and scope as set forth in the appended claims.

Without limitation, this disclosure relates to using reduced human color perception to reduce data transmission for rendering of an image on a display (e.g., on a head-mounted display of a mixed reality device). Extended Reality (XR) is an umbrella term that includes technologies that alter reality by presenting graphical elements on a display in relation to a person or a real-world environment. XR includes, and is not limited to, Virtual Reality (VR), Augmented Reality (AR), and Mixed Reality (MR) technologies.

DRAM access energy is known to contribute to a significant portion of system energy for XR devices. Today's framebuffer compression system alleviates the DRAM traffic by using a numerically lossless compression algorithm. Being numerically lossless, however, is unnecessary to preserve perceptual quality for humans. In some configurations, a perceptually lossless, but numerically lossy, system to compress DRAM traffic is disclosed. Studies that show that humans cannot discriminate colors that are close to each other. The discrimination ability becomes even weaker (i.e., more colors are perceptually indistinguishable) in our peripheral vision. Leveraging the color discrimination (in)ability, pixel colors are adjusted to reduce or minimize bit encoding cost without introducing visible artifacts. This can be coupled with lightweight architectural support that, in real-time, reduces the DRAM traffic. Psychophysical studies on human participants showed that the system can introduce little to no perceptual fidelity degradation.

### 1. INTRODUCTION

DRAM communication energy is known to contribute significantly to the system energy consumption. DRAM energy alone can consume a large percentage the total system energy consumption during XR video rendering. The DRAM bottleneck can become worse in the future with users questing for higher resolution and frame rate. An effective approach to reduce DRAM traffic is framebuffer compression, which is universally implemented in modern mobile SoCs (system on a chip; integrated circuit) for compressing any traffic in and out of the DRAM. A classic example is the Arm Frame Buffer Compressions (AFBC) technology.

Today's framebuffer compression algorithm is numerically lossless. Being numerically lossless is, however, unnecessary to preserve perceptual fidelity: more compression opportunities arise when we turn our attention to perceptual lossless. Humans cannot discriminate colors that are close to each other. Informally, this means that many colors, while differing in RGB values, are perceptually indistinguishable and thus can be encoded together-a previously underexploited opportunity for real-time image encoding.

Human color discrimination ability becomes even weaker (i.e., more colors are indistinguishable) in our peripheral vision as objects move away from fixation. The eccentricity-dependent weakening of color discrimination provides further opportunities for DRAM traffic compression. This is because some XR displays (e.g., VR displays), to provide an immersive experience, have a wide Field-of-View (FoV) of about 100 degrees. A large percentage of pixels in a frame can fall into the peripheral vision (e.g., outside 20 degrees of a gaze direction).

Leveraging the color discrimination (in)ability of human visual system, we present a new image compression algorithm for XR systems. Color perception-aware encoding can be formulated as a constraint optimization problem. The formulation can be non-convex and use iterative solvers that are not amenable to real-time execution. Leveraging empirical observations of human color discrimination abilities, we introduce some relaxations, which can transform the compression problem into a convex optimization with an analytical solution. The analytical solution, while avoiding iterative solvers, can still be compute intensive and slow to execute in real-time, in some configurations. In some configurations, a lightweight hardware extension used for encoding and decoding algorithms. The hardware can use an inherent task-level and pipeline-level parallelisms in the algorithms and can be combined with existing Base-Delta (BD) encoding without changing decoding hardware.

In some embodiments, an image encoding scheme reduces DRAM traffic in mobile XR systems. The scheme leverages the eccentricity-dependent color discrimination (in)ability of human visual systems. A lightweight and modular hardware support can enable real-time encoding. ASIC synthesis and human subject studies show that an embodiment of the encoding scheme reduced the DRAM traffic by 66.9% with little to no subjective perceptual quality degradation.

### 2. COLOR PERCEPTION AND FRAME COMPRESSION

### 2.1 Eccentricity-Dependent Color Perception

Colors and Color Spaces. In some rendering pipelines, a color can be described in the linear RGB space with three channels; each channel is a floating point number between 0 and 1. For output encoding, each channel in the linear RGB color space is transformed to the common sRGB color space, where each channel is an 8-bit integer between 0 and 255. This transformation is non-linear, called gamma encoding, and is described by the following function ƒₛ₂ᵣ, where x∈[0, 1] represents a linear RGB channel value:

$${f}_{s 2 r} ( x ) := \{ \begin{matrix}⌊ 12.92 x ⌋ & x \leq 0.0031308 \\ ⌊ 1.055 {x}^{1 / 2.4} - 0.055 ⌋ & x > 0.0031308\end{matrix} \qquad ( 1 )$$

Some studies on color discrimination operate in the DKL color space, mainly because the DKL space models the opponent process in the human visual system. The DKL space is a linear transformation away from the linear RGB color space:

$${[ R , G , B ]}^{T} = {{M}_{RGB 2 DKL} [ {K}_{1} , {K}_{2} , {K}_{3} ]}^{T} \qquad ( 2 )$$

where [R, G, B] is the color in the linear RGB space, [K1, K2, K3] is the color in the DKL space, and M_{RGB2DKL} is a 3×3 constant matrix

Color Discrimination. Humans cannot discriminate between colors that are close to each other. More formally, given a reference color κ, there exists a set of colors Eκ, in which all the colors are perceptually indistinguishable from κ. In a linear color space such as DKL and RGB, the set of equi-appearance colors in Eκ form an ellipsoid, whose center is κ. In the literature, such an ellipsoid is called a discrimination ellipsoid.

Eccentricity Dependence. Human color discrimination ability stronger in a foveal region and is weaker in the peripheral vision due to the significantly denser distribution of retinal cone cells in the fovea and the significantly higher degree of neural convergence in the periphery. For color κ, its discrimination ellipsoid Eκ is larger, i.e., includes more indistinguishable colors, as κ moves away from one's fixation. Eccentricity is the angle from the center of the retina, a.k.a., current fixation or “fovea”. Ellipsoids in a 25° plot are larger than those in a 5° plot, suggesting that the color discrimination ability is weaker in peripheral vision.

Color discrimination becomes weaker in the visual periphery. The full color discrimination function Φ, expressed below, is thus parameterized by both the reference color κ and the eccentricity e:

$$Φ : ( κ , e ) ↦ ( a , b , c ) \qquad ( 3 )$$

where (a, b, c) represents the semi-axes lengths of the discrimination ellipsoid belonging to color κ at an eccentricity e in the DKL color space. Given (a, b, c), ε_{κ}, the discrimination ellipsoid of color κ in the DKL space, is given by:

$$\frac{{( x - {κ}_{1} )}^{2}}{{a}^{2}} + \frac{{( y - {κ}_{2} )}^{2}}{{b}^{2}} + \frac{{( z - {κ}_{3} )}^{2}}{{c}^{2}} = 1 \qquad ( 4 )$$

where (κ₁, κ₂, κ₃) represent the three channels of the color κ. The function Φ can be implemented using a Radial Basis Function (RBF) network, which can be extremely efficient to implement on GPUs (Graphics Processing Units) in real time. Some AR and VR headsets, in providing an immersive experience, can have a wide FoV that is above 100°. Therefore, the vast majority of the pixel colors will fall in the peripheral vision. The eccentricity-dependent color discrimination (in) abilities of human visual system gives opportunities for better image compression.

### 2.2 Real-Time Frame Compression

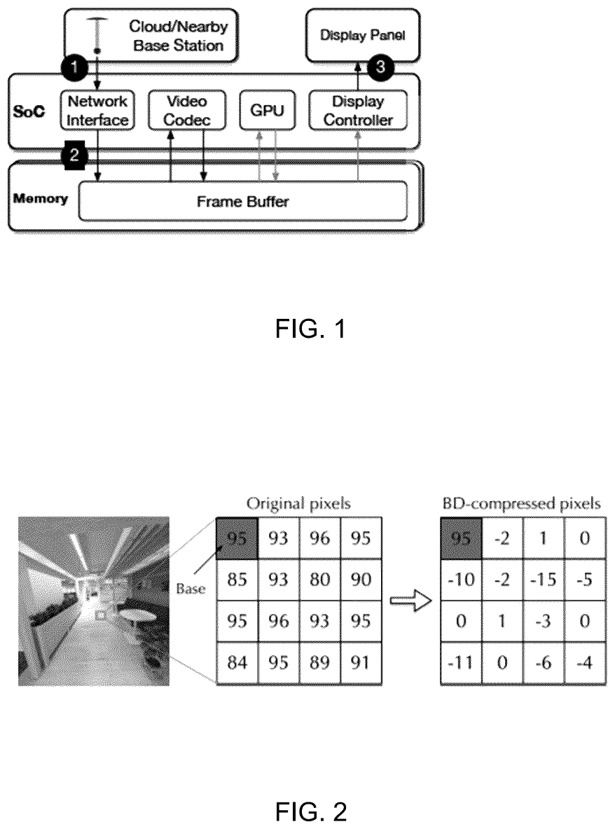

FIG. 1 depicts an embodiment of some types of data communication traffic in an XR system. Several types of data communication traffic occurs on an XR system, as illustrated in FIG. 1. Data communication traffic can include traffic through DRAM, the display interface, and/or the wireless communications with a remote rendering server. Some embodiments relate to reducing the DRAM traffic (e.g., which can occur when the different Intellectual Property (IP) blocks in the SoC communicate with each other during rendering).

Each frame, the GPU writes the frame data to the frame buffer in the GPU, which are then read by the display controller. DRAM traffic can include GPU↔frame buffer↔DRAM controller. When rendering an XR video, additional DRAM traffics can occur (e.g., between the network interface controller, the video codec, and the GPU). These traffics can also be reduced by techniques disclosed herein, especially in scenarios where remotely rendered frames are transmitted one by one rather than as a video.

Reducing DRAM traffic can be important in some situations. For example, data transfer and memory access energy can out-weigh computation energy consumption. An effective approach to reduce DRAM traffic in a rendering system is framebuffer compression, which compresses and uncompresses each frame in and out of the DRAM. To ensure a low per-frame latency, compression in VR can be done on a per-frame basis.

In some situations, base+delta (BD) compression is used. FIG. 2 is an example of BD compression. BD compression compresses each color channel and each pixel tile individually. In the example shown, sRGB color space is used. For each pixel tile (4×4 here), a base pixel (e.g., upper left corner “95” in FIG. 2) is selected, then then deltas (Δ) of the other pixels are calculated as a difference from the base pixel. The Δs are smaller in magnitude and thus use fewer bits to encode. A similar compression strategy can be applied to two, three, or more color channels.

The BD compression algorithm can be lightweight. For example, it can work completely in the image space, as opposed to the frequency domain, which can use additional, compute-intensive transformations; it uses only fixed-point addition arithmetic; and it can be implemented in parallel with other algorithms.

### 3. COLOR PERCEPTION-AWARE COMPRESSION

This section provides an example embodiment of a color perception-aware image encoding and decoding algorithm.

### 3.1 High-Level Ideas

The basic BD algorithm is numerically lossless. Our observation is that numerically lossless compression is unnecessary to preserve perceptual equivalence because the color discrimination (in)ability of the human visual system. The basic BD algorithm encodes each Δ in a tile (off of a base pixel) rather than the original pixel values. To improve the compression ratio over BD we can reduce the magnitude of the Δs, which, brings pixels more similar to each other. Under a numerically lossless constraint, however, the Δs between pixels are fixed. Our idea is to relax the constraint from numerical lossless to perceptually lossless. In this way, we can adjust pixel color values, as long as each pixel color does not go beyond its discrimination ellipsoid, to reduce or minimize the total number of bits used to encode the Δs. This encoding is numerically lossy as we intentionally change the color values, but perceptual quality is preserved.

As an example, 16 pixels in a tile are on an axis. The number of bits used to encode the entire tile is (ignoring any metadata for now):

$$B = {B}_{0} + N \times {B}_{D} \qquad ( 5 )$$

$${B}_{0} = 8 , N = 15 , {B}_{D} = ⌊ {log}_{2} ( Max - Min + 1 ) ⌋ \qquad ( 6 )$$

where B₀ being 8 denotes that 8 bits are used to encode a base pixel (assuming a common 8-bit per-channel encoding), and N being 15 denotes that there are 15 other pixels. B_{D} denotes the number of bits used to encode the Δ of each of the 15 non-base pixels.

The minimum value of BD occurs when the base pixel is chosen to be within [Min, Max], in which case BD=[log 2(Max−Min+1)]. In some situations, this is because the number of bits to encode each Δ is the same, so we accommodate the largest possible Δ, which is the difference between the maximum and minimum pixels in the tile. Therefore, to improve compression ratio we reduce (Max−Min). The adjusted pixel values can deviate from the original values, and as long as they are still within the respective ellipsoids, (Max−Min) is reduced without affecting perceptual quality. In some embodiments, bit length can be varied.

To obtain the highest compression, in some cases, interior pixels are adjusted. A challenge we address is how to design a principled algorithm that increases or maximizes the bit reduction while being lightweight to execute in real time.

### 3.2 Problem Formulation

In some embodiments, our compression algorithm can work on top of a baseline BD algorithm (e.g., with a goal is to adjust pixel colors to minimize the bit-length used to encode the Δs in a tile). The adjusted pixel tile can then go through an existing BD compression method. However, color adjustment does not violate perceptual constraints. Therefore, we can formulate a compression as a constraint optimization problem:

$${arg min}_{P} {\sum }_{C ∈ \{ R , G , B \}} {log}_{2} ⌊ max \{ {f}_{s 2 r} ( {p}^{C} ) \} - min \{ {f}_{s 2 r} ( {p}^{C} ) \} + 1 ⌋ , \qquad ( 7 a )$$

$$where p := [ {p}_{0} , {p}_{1} , … , {p}_{N - 1} ] , \qquad ( 7 b )$$

$${p}^{C} := [ {p}_{0}^{C} , {p}_{1}^{C} , … , {p}_{N - 1}^{C} ] , C ∈ \{ R , G , B \} \qquad ( 7 c )$$

$$\begin{matrix}s . t . ∀ {p}_{i} ∈ p & {p}_{i} ∈ {ℰ}_{{p}_{i}}\end{matrix} \qquad ( 7 d )$$

where p is the optimization variable, which is the collection of N pixels in a tile (Equation 7b); and pᵢ^{c} denotes channel C (R, G, or B) of i-th pixel in a linear RGB space.

The constraints (Equation 7d) provide the (convex) ellipsoid boundary for each pixel to move while maintaining perception quality. ƒₛ₂ᵣ(⋅) is the non-linear transformation from RGB to sRGB space (Section 2.1), which is where bit encoding can take place. An objective function (Equation 7a) minimizes the bit cost for encoding the Δs across all channels (e.g., it is a constant cost to encode the base pixel, e.g., 8 in the common sRGB encoding). This optimization formulation is applied to each pixel tile independently.

Unfortunately, this optimization problem may not be amenable for real-time evaluation,=because the objective function is non-convex due to the non-linearity of min, max, floor, and ƒs2r(⋅). Empirically, we found that some popular solvers in Matlab spent hours while still being stuck in local optima.

Relaxation. We introduce two relaxations that turn the problem into a convex optimization. While general convex optimizations use iterative solvers, our relaxed problem is one such that it has an analytical solution. The relaxations keep the same constraints as before (e.g., Equation 7d) and, thus, still enforce the perceptual quality. The first relaxation is based on an observation that many or most discrimination ellipsoids are elongated along either the Red Axis or the Blue axis. This can be because human visual perception is most sensitive to green lights and, thus, has the least “wiggle room” along the Green Axis.

In some configurations, instead of minimizing bit costs across all three axes, reduce minimize along only the Red Axis and/or the Blue Axis (while still having the flexibility of adjusting the channels of each of the pixels in a tile). Using the Blue Axis an example, this relaxation yields following new objective function in Equation 8a:

$${arg min}_{p} {log}_{2} ⌊ max \{ {f}_{s 2 r} ( {p}^{B} ) \} - min \{ {f}_{s 2 r} ( {p}^{B} ) \} + 1 ⌋ , \qquad ( 8 a )$$

$$⇒ {arg min}_{p} max \{ {f}_{s 2 r} ( {p}^{B} ) \} - min \{ {f}_{s 2 r} ( {p}^{B} ) \} , \qquad ( 8 b )$$

$$\tilde{⇒} {arg min}_{p} max \{ {p}^{B} \} - min \{ {p}^{B} \} . \qquad ( 8 c )$$

Second, the objective function in Equation 8a can be transformed to Equation 8b without sacrificing solution optimality, because log 2└⋅┘ is monotonically non-decreasing. We then remove the non-linear RGB to sRGB transformation function ƒₛ₂ᵣ(⋅). This removal does not preserve the solution optimality, but gives us a convex objective function in Equation 8c.

### 3.3 Analytical Solution Intuition

The relaxations introduced before can lead to an analytical solution that does not use iterative solvers. Observe that the objective function in Equation 8c minimizes the difference between the maximum and minimum values along the Blue Axis. To achieve that, we move colors closer to each other along the Blue Axis while ensuring adjusted colors stay within respective discriminative ellipsoids.

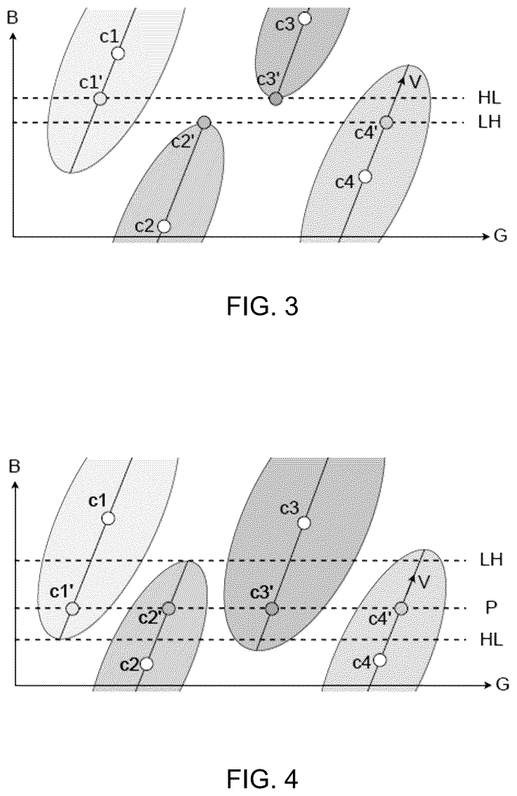

Moving colors can fall into a first case or a second case. FIG. 3 is an example embodiment of a plot of a projection of a first set of ellipsoids onto the B-G plane for the first case. FIG. 4 is an example embodiment of a plot of a projection of a second set of ellipsoids onto the B-G plane for the second case. Without losing generality, we selected to optimize along the Blue Axis to provide examples; the case along the Red Axis is similar in principle. Empty markers (C₀, C₁, C₂, C₃) denote the original colors, and the solid markers (C₁′, C₂′, C₃′, C₄′) denote the adjusted colors. In both cases, colors are adjusted along an extrema vector V.

In the first case (FIG. 3), there is not a single plane that cuts across the first set of ellipsoids. This is because the Lowest of the Highest points (LH) of the first set of ellipsoids is lower than the Highest of the Lowest points (HL) of the first set of ellipsoids. Simply put, HL>LH.

One strategy is to move each color that is higher than HL (e.g., C₁ and C₃) toward HL (e.g., C₁′ and, C₃′) and move each color lower than LH (e.g., C₂ and C₄) toward LH (e.g., C₂′ and C₄′). The movement is executed along the extrema vector V, which is the vector that connects the highest and the lowest point of an ellipsoid. After the adjustment, blue channels across the pixels are either HL or LH. That is, the maximum Δ along the Blue Axis is now HL-LH, which is the smallest gap obtained blue channels without going outside ellipsoid boundaries.

In the second case (FIG. 4), LH>HL, and there is a common plane (P) that cuts across the second set of ellipsoids. In fact, there are infinitely many such planes because LH is higher HL, and a plane between LH and HL will cut across the second set of ellipsoids. In this case, a plane between LH and HL can be selected and colors moved to that plane. For simplicity of implementation, we choose the average of the LH and the HL planes as the common plane P, and moved colors along the extrema vectors to common plane P. In this way, blue channel values are the same for the pixels so that no Δ bit used for the blue channel.

### 3.4 Overall Compression

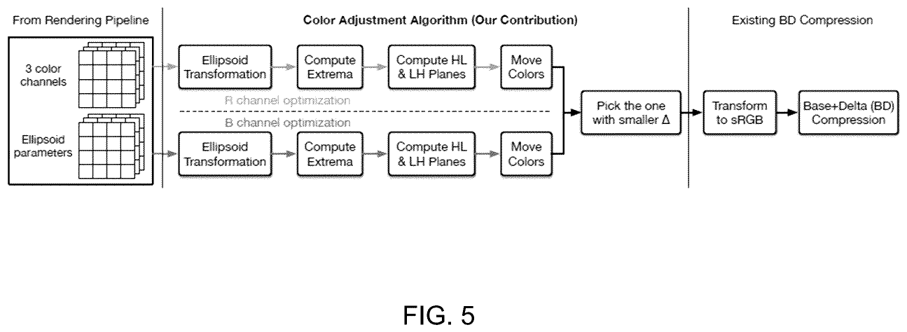

FIG. 5 is an illustration of an embodiment for how color adjustment fits in an embodiment of an overall rendering and compression pipeline. The color adjustment algorithm takes as inputs a tile of pixels (e.g., each with three channels) and the parameters of their corresponding discrimination ellipsoids. A perceptually adjusted pixel tile is generated as an output. Similar color-adjustment strategies are applied along both the Blue Axis and the Red Axis for each tile. The color axis with the better result (e.g., smaller delta Δ) is selected.

Of note, color adjustment does not directly perform compression in itself; it simply adjusts pixel colors so that the (numerically lossless) BD encoding later can achieve a higher compression rate. For example, the adjusted pixel tile can be first transformed from the linear RGB to the sRGB space, which then goes through the usual BD compression.

Ellipsoid Transformation. Discrimination ellipsoids are transformed from the DKL space to the linear RGB space, which is where color adjustment takes place (e.g., section 3.3). Though ellipsoids are axis aligned in the DKL color space, they will likely not be axis aligned after the linear transformation from the DKL to the RGB color space. Therefore, an ellipsoid in the linear RGB space takes the form of a general quadric surface:

$$Ax 2 + By 2 + Cz 2 + Dx + Ey + Fz + Gxy + Hyz + Izx + 1 = 0 \qquad ( 9 )$$

Transforming an axis-aligned ellipsoid in the DKL space to an ellipsoid in the linear RGB amounts to the following matrix multiplication:

$$[ \begin{matrix}A \\ B \\ C \\ D \\ E \\ F \\ G \\ H \\ I\end{matrix} ] = [ \begin{matrix}{( T ⊙ T )}^{⊤} & 0 \\ 0 & T \\ [ \begin{matrix}2 {T}_{00} {T}_{01} & 2 {T}_{10} {T}_{11} & 2 {T}_{20} {T}_{21} \\ 2 {T}_{01} {T}_{02} & 2 {T}_{11} {T}_{12} & 2 {T}_{21} {T}_{22} \\ 2 {T}_{00} {T}_{02} & 2 {T}_{10} {T}_{12} & 2 {T}_{20} {T}_{22}\end{matrix} ] & 0\end{matrix} ] \times [ \begin{matrix}1 / {a}^{2} t \\ 1 / {b}^{2} t \\ 1 / {c}^{2} t \\ - 2 {κ}_{1} / {a}^{2} t \\ - 2 {κ}_{2} / {b}^{2} t \\ - 2 {κ}_{3} / {c}^{2} t\end{matrix} ] , \\ t = 1 - ( \frac{{κ}_{1}^{2}}{{a}^{2}} + \frac{{κ}_{2}^{2}}{{b}^{2}} + \frac{{κ}_{3}^{2}}{{c}^{2}} ) \qquad ( 10 )$$

where

$$T = [ \begin{matrix}{T}_{00} & {T}_{01} & {T}_{02} \\ {T}_{10} & {T}_{11} & {T}_{12} \\ {T}_{20} & {T}_{21} & {T}_{22}\end{matrix} ]$$

is the constant M_{RGB2DKL} matrix in section 2.1, ⊙ is element-wise product, (κ₁, κ₂, κ₃) is the color in DKL space, and (a, b, c) are the semi-axis lengths of κ's discrimination ellipsoids. The derivation uses linear transformations.

Color Adjustment. Once we have the ellipsoids in the linear RGB space, we can perform color adjustment, which, as illustrated in FIGS. 3 & 4 and described in Sec. 3.3, can be done in three steps: 1) compute the extrema, i.e., the highest and the lowest point, of each ellipsoid; 2) compute LH and HL based on the extrema of the ellipsoids; 3) compare LH and HL and move colors along extrema vectors accordingly. Steps 2 and 3 are relatively straightforward, so here we focus on the mathematical details of Step 1.

Extrema along the Blue axis can be computed by taking the partial derivatives of the ellipsoid equation along the Red and Green axes:

$$\frac{dz}{dx} = 2 Ax + Gy + Iz + D = 0 \qquad ( 11 a )$$

$$\frac{dz}{dy} = Gx + 2 By + Hz + E = 0 \qquad ( 11 b )$$

These partial derivatives give us two planes, the intersection of which is a vector v that connects the two extrema. The extreme vector v is calculated by taking the cross product of the normal vectors of the two planes:

$$v = ( 2 A , G , I ) \times ( G , 2 B , H ) \qquad ( 12 )$$

The two extrema points H and L are then calculated by finding the intersection of v and the ellipsoid:

$$x := ( {x}_{1} , {x}_{2} , {x}_{3} ) = {M}_{RGB 2 DKL} \times {v}^{T} \qquad ( 13 a )$$

$$t = 1 / \sqrt{\frac{{x}_{1}^{2}}{{a}^{2}} + \frac{{x}_{2}^{2}}{{b}^{2}} + \frac{{x}_{3}^{2}}{{c}^{2}}} \qquad ( 13 b )$$

$$H = {M}_{RGB 2 DKL}^{- 1} \times {( {κ}_{1} + {x}_{1} t , {κ}_{2} + {x}_{2} t , {κ}_{3} + {x}_{3} t )}^{T} \\ L = {M}_{RGB 2 DKL}^{- 1} \times {( {κ}_{1} - {x}_{1} t , {κ}_{2} - {x}_{2} t , {κ}_{3} - {x}_{3} t )}^{T} \qquad ( 13 c )$$

where κ is the pixel color in the DKL space, (a, b, c) are DKL ellipsoid parameters, and M_{RGB2DKL} is the RGB to DKL transformation matrix (e.g., section 2.1). The derivation amounts to an application of line-ellipsoid intersection and linear transformations between RGB and DKL space.

Remarks on Decoding. A desired byproduct of our algorithm, in some embodiments, is that it use no change to the existing framebuffer decoding scheme-our color adjustment algorithm simply changes the input to BD. During decoding (e.g., by the display controller), the existing BD decoder will construct the sRGB values from the BD-encoded data, which are then sent to the display. The exact BD encoding format can vary across implementations.

### 4. EXAMPLE HARDWARE ARCHITECTURE

The analytical compression algorithm, while avoiding iterative solvers, can still be compute intensive and slow to execute in real-time, in some embodiments. We implement it as a GPU shader. This section describes an embodiment of a lightweight hardware design that accelerates the compression algorithm. Section 4.1 describes how custom hardware can fit into an overall system. Section 4.2 describes details of an embodiment of hardware.

### 4.1 Hardware Overview

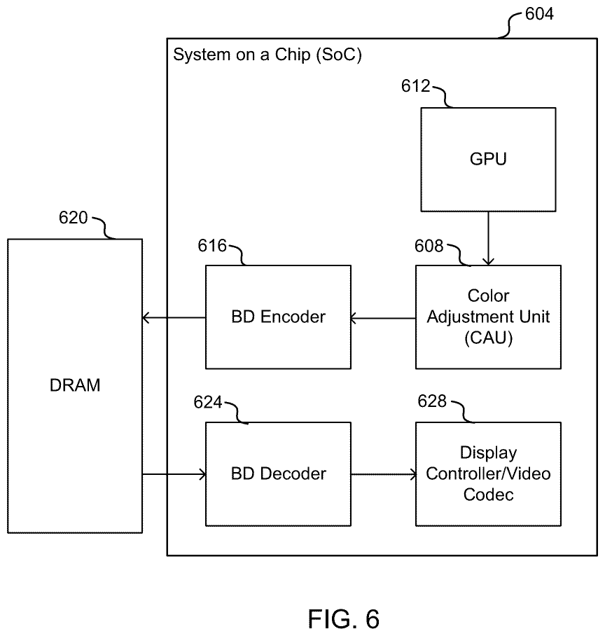

FIG. 6 is a block diagram of an embodiment of a system on a chip (SoC) 604 comprising a Color Adjustment Unit (CAU) 608. The CAU 608 is configured to execute the pixel adjustment algorithm described in section 3. The CAU 608 reads its input from an on-chip buffer, which stores the pixels and the discrimination ellipsoid parameters generated by a GPU 612. In this embodiment, the GPU 612 is responsible for generating the per-pixel discrimination ellipsoids.

The output of the CAU 608 enters a BD encoder 616. For example, the BD encoder 616 is an existing BD framebuffer encoder, which writes encoded data to the DRAM 620. Data from the DRAM 620 passes through a BD decoder 624 and is sent to a display controller 628, which reconstructs the sRGB pixels for a display. As shown in FIG. 6, the CAU 608 works with, rather than replaces, BD encoding, and/or the CAU 608 does not change an existing decoding architecture.

### 4.2 Color Adjustment Unit

In some embodiments, the CAU 608 comprises an array of Processing Elements (PEs), each of which is designed to adjust colors for one tile of pixels (e.g., tiles can be 2×2, 3×3, 4×4, 5×5, 2×3, 2×4, 3×5, 4×6, etc). Each PE interfaces with a dedicated Pending Buffer, which holds information of the pixel tiles generated from the GPU 612. Having more PEs allows the system to compress multiples tiles simultaneously.

Pipelining. The PE is pipelined to accept a new tile every cycle. In some embodiments, three main phases of a pipeline are used. The first phase computes the extrema. The second phase uses reduction trees to calculate HL and LH from the extrema. The third phase moves colors along the extrema vector.

Phase 1, Compute Extrema Blocks. This component calculates the extrema of pixels in a tile, which is parallelizable across pixel and, thus, has multiple parallel units, each of which is responsible for one pixel. This can be the most compute intensive block in the CAU, since it involves multiple divisions and square root operations. The division and square root hardware implements Equation 13b, and an adder and subtractor circuit implements Equation 13c. The DKL-RGB transformations in Equation 13c and Equation 13a are implemented through matrix vector multiplication executed on a 3×3 MAC array.

Phase 2, Compute Planes Blocks. The extrema calculated in phase 1 enters this unit, which finds the channel value for the HL plane (maximum of the minima) and LH (minimum of the maxima) plane. The phase is implemented using two reduction (comparator) trees to generate both planes simultaneously.

Phase 3, Color Shift Blocks. This phase takes the original color values and the two planes as input and outputs modified color values. This phase is control-flow heavy, as it involves multiple condition checks, e.g., testing the relationship between a point and a plane. A custom data path in the CAU 608 avoids much of the inefficiencies surrounding control flows that can be detrimental to GPU 612 performance.

Pending Buffer. Pending Buffers can be used to store intermediate pixels and their discrimination ellipsoids from the GPU 612 before they are used by the CAU 608. Each buffer is interfaced with a dedicated PE and, thus, contains the data for the pixel tiles to be used by the PE.

The buffers are properly sized to not stall or starve the CAU pipeline. To be independent of the exact GPU microarchitecture details, a conservative estimation of the buffer size is made. For example, we allocated enough space in the buffer such that it can hold the pixels generated by the GPU 612 in each CAU 608 cycle even if the GPU 612 is fully utilized, in which case each shader core in the GPU 612 generates 1 pixel/GPU cycle. Note that the GPU 612 and CAU 608 cycle times need not be the same. The number of PEs in a CAU 608 is set so as to not stall either the GPU 612 or the CAU 608.

### 5. EXAMPLE PROCESS

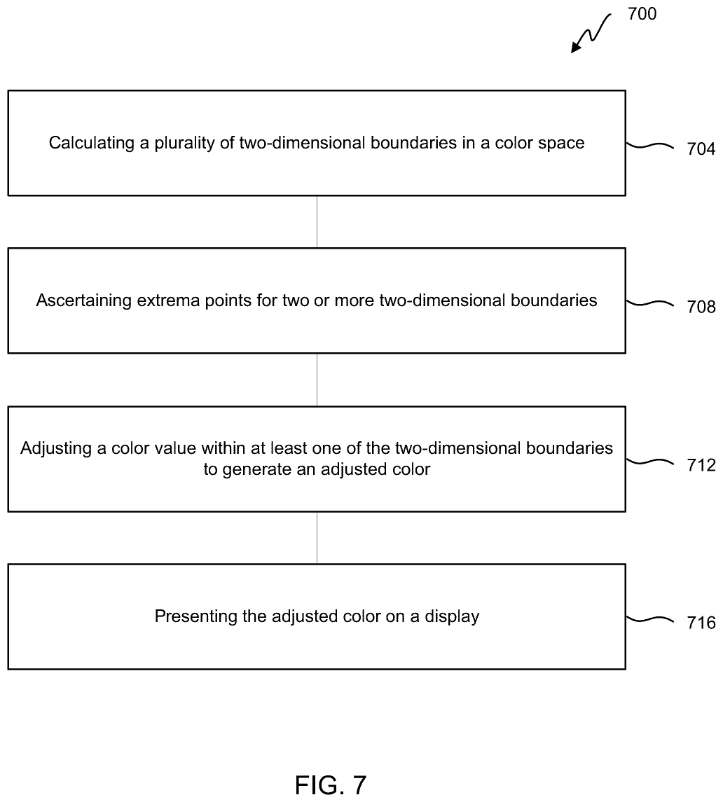

FIG. 7 depicts and embodiment of a process 700 for memory-efficient encoding in an extended-reality device. Process 700 begins in step 704 with calculating a plurality of two-dimensional boundaries in a color space. The two-dimensional boundary is ascertained based on human color discrimination. For example, the two-dimensional boundary is a cross section of an ellipsoid in a color space. The ellipsoid can be function of an angle of a field of view of a person (e.g., eccentricity, the ellipsoid is larger for pixels in a periphery of a field of view of the user of the extended-reality device). In some embodiments, the color space is a first color space, and calculating a plurality of color-discrimination ellipsoids in the first color space comprises transforming a plurality of axis-aligned ellipsoids from a second color space into a plurality of ellipsoids in the first color space. For example, the second color space is the DKL (Derrington-Krauskopf-Lennie) space; and the first color space is the linear RGB (Red, Green, Blue) space. Each two-dimensional boundary corresponds with a color value for a pixel of an image. FIGS. 3 and 4 show examples of two-dimensional boundaries in a color space. In some embodiments, ellipsoids are provided by the GPU

In step 708 extrema points for two or more two-dimensional boundaries of the plurality of two-dimensional boundaries are ascertained. For example, H and L are ascertained for each of the plurality of color-discrimination ellipses, where His a high value of the ellipse and L is a low value of the ellipse. A HL value and a LH value are ascertained, where HL is a highest of low values L and LH is a lowest of high values H for the plurality of color-discrimination ellipses.

In Step 712 a color value within at least one of the two-dimensional boundaries is adjusted to generate an adjusted color to reduce variances of color values for a color channel, based on ascertaining extrema points for the two or more two-dimensional boundaries. Adjusting color can be based on HL and/or LH. For example, the color value of the at least one of the plurality of ellipsoids is adjusted to equal HL or LH based on HL being greater than LH (e.g., as shown in FIG. 3). In another example, the color value of the at least one of the plurality of ellipsoids is adjusted to a value P based on HL being greater than LH, wherein the value P is a value equal to or less than LH and equal to or greater than HL (e.g., as shown in FIG. 4). The value P can be an average of HL and LH. In some configurations, the color channel is blue and/or red, but not green.

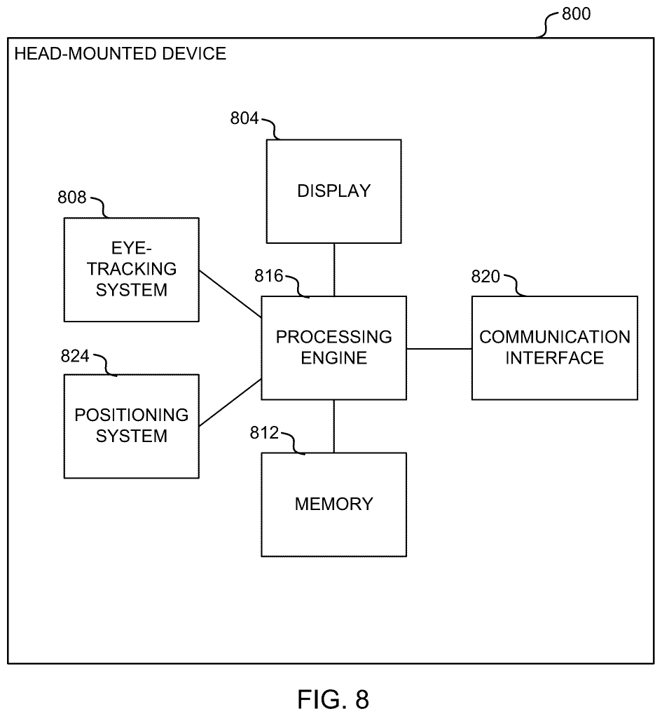

In step 716, the adjusted color is presented on a display. For example, data for the adjusted color is transmitted from the CAU 608 in FIG. 6 to the BD encoder 616, from the BD Encoder to the DRAM 620, from the DRAM to the BD decoder 624, and from the BD decoder 624 to the Display Controller 628 for display by a pixel of the display 804 in FIG. 8.

### 6. EXAMPLE DISPLAY SYSTEM

FIG. 8 depicts an embodiment of a head-mounted device 800. The head-mounted device 800 can be an Extended-Reality (XR) device, such as a Virtual-Reality (VR) device or an Augmented-Reality (AR) device. The head-mounted device 800 is intended to be worn by a user (e.g., a head-mounted display (HMD)).

The head-mounted device 800 comprises a display 804, an eye-tracking system 808, memory 812, a processing engine 816, a communications interface 820, and/or a positioned system 824.

The display 804 is arranged to present a video stream to a user of the head-mounted device 800. The eye-tracking system 808 is arranged to track a gaze direction of the user. The eye-tracking system 808 comprises cameras configured to acquire images of the eyes of the user while the user is viewing the display 804. The eye-tracking system 808 can further comprise one or more IR light sources, optical components, electronics, machine-learning algorithms, etc. for tracking the eyes. The eye-tracking system 808 calculates a gaze direction of the user in relation to the display 804 based on acquiring images of the eyes. The memory 812 comprises one or more memory devices. The one or more memory devices of the memory 812 can be contained in the head-mounted device 800 or be distributed, e.g., between the head-mounted device 800, a base station, and/or one or more remote device (e.g., connected via the Internet or a smart device).

The processing engine 816 comprises one or more processors. Instructions (e.g., code) are stored the memory 812 and, when executed, cause the processing engine 816 to perform one or more steps. The one or more processors in the processing engine 816 can be contained in the head-mounted device 800 or be distributed, e.g., between the head-mounted device 800, the base station, and/or the one or more remote devices (e.g., connected via the Internet or a smart device).

The communication interface 820 can comprise a user interface and/or other devices for communication between the head-mounted device 800 and other devices (e.g., wired or wireless communication with a mobile device, such as a smartphone or tablet, wifi, or the base station).

The positioning system 824 comprises sensors for positioning the head-mounted device 800 with respect to an environment and/or to calculation motion relative to itself. For example, the positioned system 824 can comprise accelerometers that are part of an inertial-measurement unit (IMU), external facing cameras (e.g., for SLAM), and/or processors for receiving position and/or orientation data sent to the head-mounted device 800.

### 7. EXAMPLE COMPUTER SYSTEM

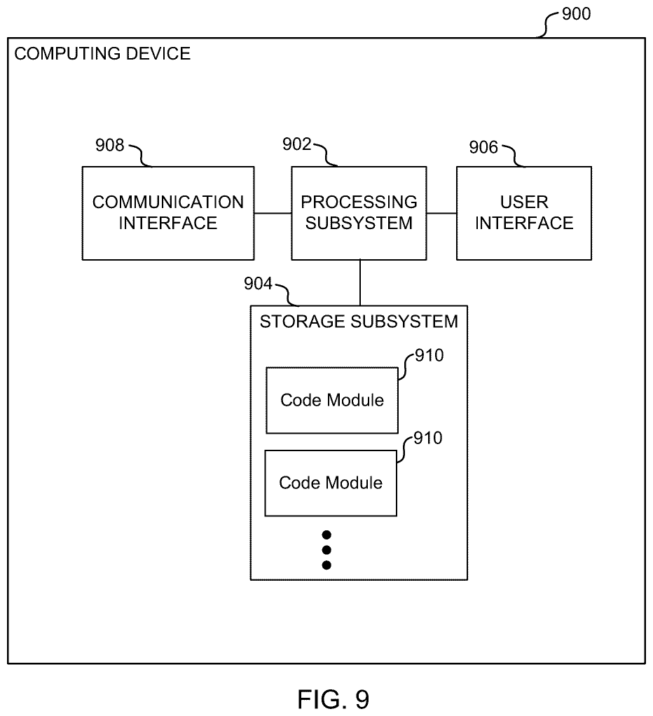

FIG. 9 is a simplified block diagram of a computing device 900. Computing device 900 can implement some or all functions, behaviors, and/or capabilities described above that would use electronic storage or processing, as well as other functions, behaviors, or capabilities not expressly described. Computing device 900 includes a processing subsystem 902, a storage subsystem 904, a user interface 906, and/or a communication interface 908. Computing device 900 can also include other components (not explicitly shown) such as a battery, power controllers, and other components operable to provide various enhanced capabilities. In various embodiments, computing device 900 can be implemented in a desktop or laptop computer, mobile device (e.g., tablet computer, smart phone, mobile phone), wearable device (e.g., a VR or AR device), media device, application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, or electronic units designed to perform a function or combination of functions described above.

Storage subsystem 904 can be implemented using a local storage and/or removable storage medium, e.g., using disk, flash memory (e.g., secure digital card, universal serial bus flash drive), or any other non-transitory storage medium, or a combination of media, and can include volatile and/or non-volatile storage media. Local storage can include random access memory (RAM), including dynamic RAM (DRAM), static RAM (SRAM), or battery backed up RAM. In some embodiments, storage subsystem 904 can store one or more applications and/or operating system programs to be executed by processing subsystem 902, including programs to implement some or all operations described above that would be performed using a computer. For example, storage subsystem 904 can store one or more code modules 910 for implementing one or more method steps described above.

A firmware and/or software implementation may be implemented with modules (e.g., procedures, functions, and so on). A machine-readable medium tangibly embodying instructions may be used in implementing methodologies described herein. Code modules 910 (e.g., instructions stored in memory) may be implemented within a processor or external to the processor. As used herein, the term “memory” refers to a type of long term, short term, volatile, nonvolatile, or other storage medium and is not to be limited to any particular type of memory or number of memories or type of media upon which memory is stored.

Moreover, the term “storage medium” or “storage device” may represent one or more memories for storing data, including read only memory (ROM), RAM, magnetic RAM, core memory, magnetic disk storage mediums, optical storage mediums, flash memory devices and/or other machine-readable mediums for storing information. The term “machine-readable medium” includes, but is not limited to, portable or fixed storage devices, optical storage devices, wireless channels, and/or various other storage mediums capable of storing instruction(s) and/or data.

Furthermore, embodiments may be implemented by hardware, software, scripting languages, firmware, middleware, microcode, hardware description languages, and/or any combination thereof. When implemented in software, firmware, middleware, scripting language, and/or microcode, program code or code segments to perform tasks may be stored in a machine-readable medium such as a storage medium. A code segment (e.g., code module 910) or machine-executable instruction may represent a procedure, a function, a subprogram, a program, a routine, a subroutine, a module, a software package, a script, a class, or a combination of instructions, data structures, and/or program statements. A code segment may be coupled to another code segment or a hardware circuit by passing and/or receiving information, data, arguments, parameters, and/or memory contents. Information, arguments, parameters, data, etc., may be passed, forwarded, or transmitted by suitable means including memory sharing, message passing, token passing, network transmission, etc.

Implementation of the techniques, blocks, steps and means described above may be done in various ways. For example, these techniques, blocks, steps and means may be implemented in hardware, software, or a combination thereof. For a hardware implementation, the processing units may be implemented within one or more ASICs, DSPs, DSPDs, PLDs, FPGAs, processors, controllers, micro-controllers, microprocessors, other electronic units designed to perform the functions described above, and/or a combination thereof.

Each code module 910 may comprise sets of instructions (codes) embodied on a computer-readable medium that directs a processor of a computing device 900 to perform corresponding actions. The instructions may be configured to run in sequential order, in parallel (such as under different processing threads), or in a combination thereof. After loading a code module 910 on a general-purpose computer system, the general-purpose computer is transformed into a special purpose computer system.

Computer programs incorporating various features described herein (e.g., in one or more code modules 910) may be encoded and stored on various computer readable storage media. Computer readable media encoded with the program code may be packaged with a compatible electronic device, or the program code may be provided separately from electronic devices (e.g., via Internet download or as a separately packaged computer-readable storage medium). Storage subsystem 904 can also store information useful for establishing network connections using the communication interface 908.

User interface 906 can include input devices (e.g., touch pad, touch screen, scroll wheel, click wheel, dial, button, switch, keypad, microphone, camera(s) for detecting gestures, etc.), as well as output devices (e.g., video screen, indicator lights, speakers, headphone jacks, virtual- or augmented-reality display, etc.), together with supporting electronics (e.g., digital-to-analog or analog-to-digital converters, signal processors, etc.). A user can operate input devices of user interface 906 to invoke the functionality of computing device 900 and can view and/or hear output from computing device 900 via output devices of user interface 906. For some embodiments, the user interface 906 might not be present (e.g., for a process using an ASIC).

Processing subsystem 902 can be implemented as one or more processors (e.g., integrated circuits, one or more single-core or multi-core microprocessors, microcontrollers, central processing unit, graphics processing unit, etc.). In operation, processing subsystem 902 can control the operation of computing device 900. In some embodiments, processing subsystem 902 can execute a variety of programs in response to program code and can maintain multiple concurrently executing programs or processes. At a given time, some or all of a program code to be executed can reside in processing subsystem 902 and/or in storage media, such as storage subsystem 904. Through programming, processing subsystem 902 can provide various functionality for computing device 900. Processing subsystem 902 can also execute other programs to control other functions of computing device 900, including programs that may be stored in storage subsystem 904.

Communication interface 908 can provide voice and/or data communication capability for computing device 900. In some embodiments, communication interface 908 can include radio frequency (RF) transceiver components for accessing wireless data networks (e.g., Wi-Fi network; 3G, 4G/LTE; etc.), mobile communication technologies, components for short-range wireless communication (e.g., using Bluetooth communication standards, NFC, etc.), other components, or combinations of technologies. In some embodiments, communication interface 908 can provide wired connectivity (e.g., universal serial bus, Ethernet, universal asynchronous receiver/transmitter, etc.) in addition to, or in lieu of, a wireless interface. Communication interface 908 can be implemented using a combination of hardware (e.g., driver circuits, antennas, modulators/demodulators, encoders/decoders, and other analog and/or digital signal processing circuits) and software components. In some embodiments, communication interface 908 can support multiple communication channels concurrently. In some embodiments, the communication interface 908 is not used.

It will be appreciated that computing device 900 is illustrative and that variations and modifications are possible. A computing device can have various functionality not specifically described (e.g., voice communication via cellular telephone networks) and can include components appropriate to such functionality.

Further, while the computing device 900 is described with reference to particular blocks, it is to be understood that these blocks are defined for convenience of description and are not intended to imply a particular physical arrangement of component parts. For example, the processing subsystem 902, the storage subsystem 904, the user interface 906, and/or the communication interface 908 can be in one device or distributed among multiple devices.

Further, the blocks need not correspond to physically distinct components. Blocks can be configured to perform various operations, e.g., by programming a processor or providing appropriate control circuitry, and various blocks might or might not be reconfigurable depending on how an initial configuration is obtained. Embodiments of the present invention can be realized in a variety of apparatus including electronic devices implemented using a combination of circuitry and software. Electronic devices described herein can be implemented using computing device 900.

Various features described herein, e.g., methods, apparatus, computer-readable media and the like, can be realized using a combination of dedicated components, programmable processors, and/or other programmable devices. Processes described herein can be implemented on the same processor or different processors. Where components are described as being configured to perform certain operations, such configuration can be accomplished, e.g., by designing electronic circuits to perform the operation, by programming programmable electronic circuits (such as microprocessors) to perform the operation, or a combination thereof. Further, while the embodiments described above may refer to specific hardware and software components, those skilled in the art will appreciate that different combinations of hardware and/or software components may also be used and that particular operations described as being implemented in hardware might be implemented in software or vice versa.

Embodiments and examples were chosen and described to explain the principles of the invention and practical applications to thereby enable others skilled in the art to best utilize the invention in various embodiments and with various modifications as are suited to the particular use contemplated. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner.

Specific details are given in the description to provide a thorough understanding of exemplary configurations including implementations. However, configurations may be practiced without these specific details. For example, well-known circuits, processes, algorithms, structures, and techniques have been shown without unnecessary detail to avoid obscuring the configurations. This description provides example configurations only and does not limit the scope, applicability, or configurations of the claims. Rather, the preceding description of the configurations will provide an enabling description for implementing described techniques. Various changes may be made in the function and arrangement of elements without departing from the spirit or scope of the disclosure.

Having described several example configurations, various modifications, alternative constructions, and equivalents may be used without departing from the spirit of the disclosure. For example, the above elements may be components of a larger system, wherein other rules may take precedence over or otherwise modify the application of the technology. Also, steps may be undertaken before, during, or after the above elements are considered. Accordingly, the above description does not bind the scope of the claims.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. Additionally, the order of the operations may be re-arranged. A process is terminated when its operations are completed, but could have additional steps not included in the figure. A process may correspond to a method, a function, a procedure, a subroutine, a subprogram, etc.

A recitation of “a”, “an”, or “the” is intended to mean “one or more” unless specifically indicated to the contrary.

All patents, patent applications, publications, and descriptions mentioned here are incorporated by reference in their entirety for all purposes. None is admitted to be prior art.

What is claimed is:

1. A system, for memory-efficient encoding in an extended-reality device, comprising:
a display; and
one or more memory devices comprising instructions that, when executed by one or more processors, causes the one or more processors to perform the following steps:
calculating a plurality of two-dimensional boundaries in a color space;
ascertaining extrema points for two or more two-dimensional boundaries of the plurality of two-dimensional boundaries;
adjusting a color value within at least one of the two-dimensional boundaries to generate an adjusted color that reduces variances of color values for a color channel, based on ascertaining the extrema points for the two or more two-dimensional boundaries; and
presenting the adjusted color on the display.

2. The system of claim 1, wherein the two-dimensional boundaries are ascertained based on human color discrimination.

3. The system of claim 1, wherein:
the plurality of two-dimensional boundaries are cross sections from a plurality of color-discrimination ellipsoids;
ascertaining extrema points comprises:
ascertaining H and/or L for each of the plurality of the two-dimensional boundaries, where His a high value of an ellipse and L is a low value of the ellipse; and
identifying a HL value and a LH value, where HL is a highest of low values L and LH is a lowest of high values H for the plurality of two-dimensional boundaries; and
adjusting the color value within at least one of the two-dimensional boundaries to reduce variances of color values for the color channel is based on the HL value and/or the LH value.

4. The system of claim 3, wherein the color value in the at least one of the two-dimensional boundaries is adjusted to equal HL or LH, based on HL being greater than LH.

5. The system of claim 3, wherein each ellipsoid of the plurality of color-discrimination ellipsoids corresponds to a color for a pixel in an image.

6. A method for memory-efficient encoding in an extended-reality device, the method comprising:
calculating a plurality of two-dimensional boundaries in a color space;
ascertaining extrema points for two or more two-dimensional boundaries of the plurality of two-dimensional boundaries;
adjusting a color value within at least one of the two-dimensional boundaries to generate an adjusted color that reduces variances of color values for a color channel, based on ascertaining the extrema points for the two or more two-dimensional boundaries; and
presenting the adjusted color on a display.

7. The method of claim 6, wherein the two-dimensional boundaries are ascertained based on human color discrimination and a function of an angle of a field of view of a person.

8. The method of claim 6, wherein:
the plurality of two-dimensional boundaries are cross sections from a plurality of color-discrimination ellipsoids;
ascertaining extrema points comprises:
ascertaining H and/or L for each of the plurality of the two-dimensional boundaries, where His a high value of an ellipse and L is a low value of the ellipse; and
identifying a HL value and a LH value, where HL is a highest of low values L and LH is a lowest of high values H for the plurality of two-dimensional boundaries; and
adjusting the color value within at least one of the two-dimensional boundaries to reduce variances of color values for the color channel is based on the HL value and/or the LH value.

9. The method of claim 8, wherein the color value in the at least one of the two-dimensional boundaries is adjusted to equal HL or LH, based on HL being greater than LH.

10. The method of claim 8, wherein the color value in the at least one of the two-dimensional boundaries is adjusted to a value P, based on HL being greater than LH, wherein the value P is a value equal to or less than LH and equal to or greater than HL.

11. The method of claim 10, wherein the value P is an average of HL and LH.

12. The method of claim 8, wherein each ellipsoid of the plurality of color-discrimination ellipsoids corresponds to a color for a pixel in an image.

13. The method of claim 6, wherein the color channel is blue or red and not green.

14. A memory device comprising instructions that, when executed by one or more processors, cause the one or more processors to perform the following steps:
calculating a plurality of two-dimensional boundaries in a color space;
ascertaining extrema points for two or more two-dimensional boundaries of the plurality of two-dimensional boundaries;
adjusting a color value within at least one of the two-dimensional boundaries to generate an adjusted color that reduces variances of color values for a color channel, based on ascertaining extrema points for the two or more two-dimensional boundaries; and
presenting the adjusted color on a display.

15. The memory device of claim 14, wherein:
the plurality of two-dimensional boundaries are cross sections from a plurality of color-discrimination ellipsoids;
ascertaining extrema points comprises:
ascertaining H and/or L for each of the plurality of the two-dimensional boundaries, where H is a high value of an ellipse and L is a low value of the ellipse; and
identifying a HL value and a LH value, where HL is a highest of low values L and LH is a lowest of high values H for the plurality of two-dimensional boundaries; and
adjusting the color value within at least one of the two-dimensional boundaries to reduce variances of color values for the color channel is based on the HL value and/or the LH value.

16. The memory device of claim 15, wherein the color value in the at least one of the two-dimensional boundaries is adjusted to a value P, based on HL being greater than LH, wherein the value P is a value equal to or less than LH and equal to or greater than HL.

17. The memory device of claim 15, wherein each ellipsoid of the plurality of color-discrimination ellipsoids corresponds to a color for a pixel in an image.

18. The memory device of claim 14, wherein:
the color space is a first color space; and
calculating the plurality of two-dimensional boundaries comprises transforming a plurality of axis-aligned ellipsoids from a second color space into a plurality of color-discrimination ellipsoids in the first color space.

19. The memory device of claim 18, wherein:
the second color space is the DKL (Derrington-Krauskopf-Lennie) space; and
the first color space is the linear RGB (Red, Green, Blue) space.

20. The memory device of claim 14, wherein:
the color channel is a first color channel,
the instructions are configured to further cause the one or more processors to reduce variances of color values for a second color channel; and
neither the first color channel nor the second color channel is green.
